(19) United States
(12) Patent Application Publication
(10) Pub. No.: US 2003/0055643 A1
(43) Pub. Date: Mar. 20, 2003

(54) Method for controlling a voice input and output

(76) Inventors: Stefan Woestemeyer, Hildesheim (DE); Holger Wall, Hildesheim (DE)

Correspondence Address: KENYON & KENYON, ONE BROADWAY, NEW YORK, NY, 10004, US

(21) Appl. No.: 10/110,908

(22) PCT Filed: Jul. 20, 2001
(86) PCT No.: PCT/DE01/02743

(30) Foreign Application Priority Data
Aug. 18, 2000 (DE) 100 40 466.9

(51) Int. Cl. G10L 21/00

(52) U.S. Cl. 704/251; 704/275

(57) ABSTRACT

A method for controlling a voice input and output is proposed, in which a voice output is interrupted by a user input and a voice input is thereby activated, so that a user is not required to wait for the entire voice output until a voice input, but may react immediately. In this manner, the user acceptance and the safety for the user are increased, in particular when implemented in a motor vehicle.

### FIELD OF THE INVENTION

The present invention relates to a method for controlling a voice input and output.

### BACKGROUND INFORMATION

PCT Publication No. 96/27842 describes a navigation system in which a user is prompted by the navigation system to input a destination, for instance. An input prompt is output by the navigation system in voice form via loudspeaker. A user of the navigation system replies and the answers are evaluated by voice recognition. However, for a user to be able to answer, he must wait for the question posed by the navigation system. Since there is no possibility of ending the question prematurely and implementing an input, a user has to wait until the question is output in its entirety, even if it is already clear after hearing a few words of the question what kind of input is expected of the user. This prolongs the input time for a destination unnecessarily, especially if a user is already experienced in the use of the navigation system, thus decreasing the user's willingness to use the navigation system, or a user in traffic is disturbed or distracted by long interrogative sentences of the navigation system that he/she is unable to interrupt.

### SUMMARY OF THE INVENTION

The method according to the present invention has the advantage over the related art that a user may interrupt a voice output at any time and implement a voice input immediately afterwards. Thus, as soon as the user understands what kind of input is expected of him, the user may react by user input and implement a voice input, which improves user acceptance of a voice input/output. The time required for a dialogue between a voice input/output unit and a user is especially reduced if the user is already experienced in the use of the voice input/output unit.

Advantageous further refinements and improvements of the method indicated in the main claim are rendered possible by measures specified in the dependent claims. It is particularly advantageous that a microphone is activated during the voice output, so that the voice output is interrupted when it is detected that a user has spoken a word. By thus implementing user input by a spoken word, a user may already begin his voice input by speaking a word while the voice output is still outputting words. No activation of a control element is required in this context, so that a driver of a motor vehicle will not be affected in the control of the vehicle.

It is also advantageous if the voice output is only interrupted by a certain word, since the method according to the present invention may then be used even when a conversation is conducted in the vicinity of the microphone, for instance, when several people are sitting in a vehicle and talking with each other. This prevents the voice output from being interrupted and a voice input from being activated as soon as any spoken word is detected.

It is also advantageous to interrupt the voice output by pressing a key. This is especially advantageous when an interruption by a spoken word has proven ineffective, for instance as a result of noise disturbance. It is particularly advantageous in this context that the voice input and output may be entirely deactivated by pressing a key and, using operating elements, a switch implemented, for instance, to operating a device associated with the voice input/output. This is especially advantageous when a user of the voice input/output happens to be on the telephone or when loud noise disturbances would overly impair the use of a voice input. Deactivation of the voice input/output is advantageously achieved, for instance, by pressing the key twice or by holding the key down for a longer period of time.

Furthermore, it is advantageous that the voice output is activated again after the voice input has been completed, so that a dialogue may develop between the voice input/output and a user. It is particularly advantageous in this context if the text output by the voice output includes a prompt for a subsequent voice input, since a first-time user of the voice input/output unit is taught its correct use in this way.

It is also advantageous to use the method according to the present invention for inputting the destination in a navigation device in a motor vehicle, because the driver of a vehicle must fully concentrate on the road traffic and would be needlessly distracted by a voice output that takes too long. Also, a user generally uses the navigation device in a vehicle repeatedly, so that a user soon becomes quite familiar with the prompts for inputting the destination that are issued to him/her by the navigation device via the voice output.

### BRIEF DESCRIPTION OF THE DRAWINGS

FIG. 1 shows a navigation device in a motor vehicle, having a voice input/output according to the present invention.

FIG. 2 shows a sequence of a method for controlling voice input and output according to the present invention.

FIG. 3 shows a second sequence for controlling a voice input and output according to the present invention.

### DETAILED DESCRIPTION

The method for controlling voice input and output according to the present invention may be used at any interface between human and machine where a voice output is implemented by a machine and a voice input by a person. Such a method is of particular advantage in interfaces between man and machine where a person is unable to read a prompt for a voice input while steering a vehicle, a plane or some other machine, because he must concentrate on a traffic event, on operational parameters of the vehicle or an operational sequence of the machine. Furthermore, a dialogue with an electronic device, for instance, a household device, using the voice input/output according to the present invention will be easier for people with reduced visual capacity. The method is also suitable for the remote control of a processing unit via telephone. Hereinafter, the method according to the present invention is described in terms of a control for a voice input/output that is connected to a navigation device in a motor vehicle.

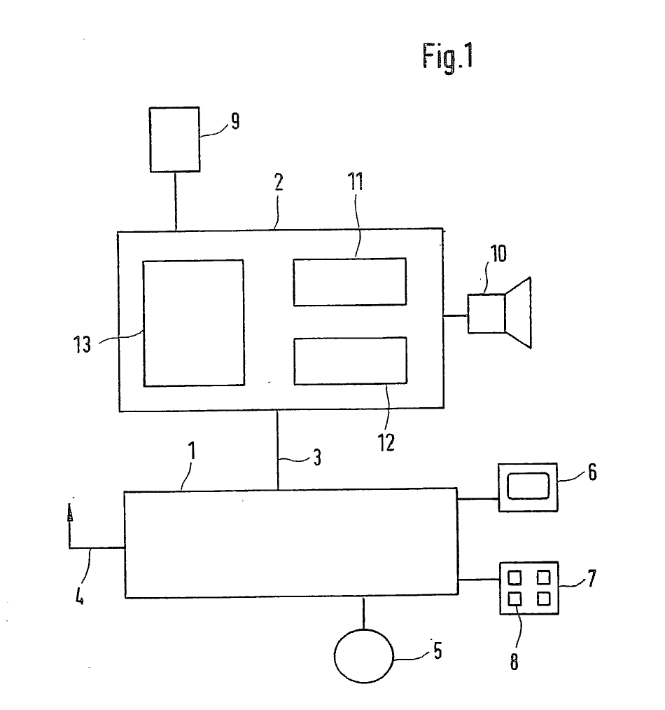

In FIG. 1, a navigation device 1 in a motor vehicle is connected via a data transmission circuit 3 to a voice input/output unit 2. Navigational device 1 is also connected to a GPS-receiver 4, a data memory 5, a display unit 6 and an input unit 7 having pushbuttons 8. The voice input/output unit 2 is coupled to a microphone 9 and a loudspeaker 10. Furthermore, voice input/output unit 2 has a processing unit 11, a memory unit 12 and a filter unit 13.

Navigation device 1, which is not further shown in FIG. 1, is used to calculate a route from a starting point to a destination point, to display a route in display unit 6 and to output driving instructions via the voice-output function of voice input/output unit 2 using loudspeaker 10. A route is calculated by accessing a digital road map with a stored road and route network, which is stored in data memory unit 5. A starting position is ascertained with the aid of position determining of navigation device 1 via GPS-receiver 4 (GPS=Global Positioning System). A destination may be input via keys 8 located on input unit 7, preferably by choosing a destination from a selection displayed in display unit 6. In accordance with the present invention, a destination may also be input via voice input/output unit 2. In this case, voice input/output unit 2 will not only output driving instructions, but also a prompt to input a destination. A prompt to begin a voice output is conveyed to voice input/output unit 2 by navigation device 1, via data transmission circuit 3. Processing unit 11 determines the corresponding voice output and outputs words via loudspeaker 10 by combining into words voice components stored in digital form in memory unit 12. No response from the user is required in the outputting of a driving instruction. However, if a user inputs a destination by voice after being prompted by voice input/output unit 2, the words spoken by the user are detected by microphone 9. Filter unit 13 filters out interference from the signal detected via microphone 9, such as background noise or an audio signal output simultaneously via loudspeaker 10. Processing unit 11 analyzes the signal output by filter unit 13 and detected via microphone 9, and implements voice recognition by accessing the voice elements stored in memory unit 12. With the aid of voice recognition, the ascertained destination is forwarded to navigation device 1 via data transmission circuit 3. However, a complex input, such as an entire address, is generally required for inputting a destination. However, if a voice input takes too long, the probability of successful voice recognition diminishes. For that reason, individual features of the destination, such as the address data regarding the name of the town, street name and house number, are requested individually in a dialogue between voice input/output unit 2 and a user. In doing so, for example, the voice input/output-unit puts out the question via loudspeaker 10: “In what town is the destination located?” The user thereupon speaks the name of a town into microphone 9, which processing unit 11 recognizes through voice recognition and conveys to navigation device 1. In a preferred embodiment of the present invention, the town as understood by voice input/output unit 2 is subsequently output via loudspeaker 10 for verification. If the user does not correct the output town name, the question is posed in a next step: “On what street is the destination located?” A dialogue between voice input/output unit 2 and the user is then conducted until a destination has been unambiguously determined. A dialogue in this context is not limited to the input of an address, but may also involve, for instance, a search for a hotel, a restaurant or a tourist attraction. In a further exemplary embodiment, not shown in FIG. 1, it is also possible to combine voice input/output unit 2 with navigation device 1 in one apparatus and/or, in this connection, to combine processing unit 11 with a processing unit of navigation device 1.

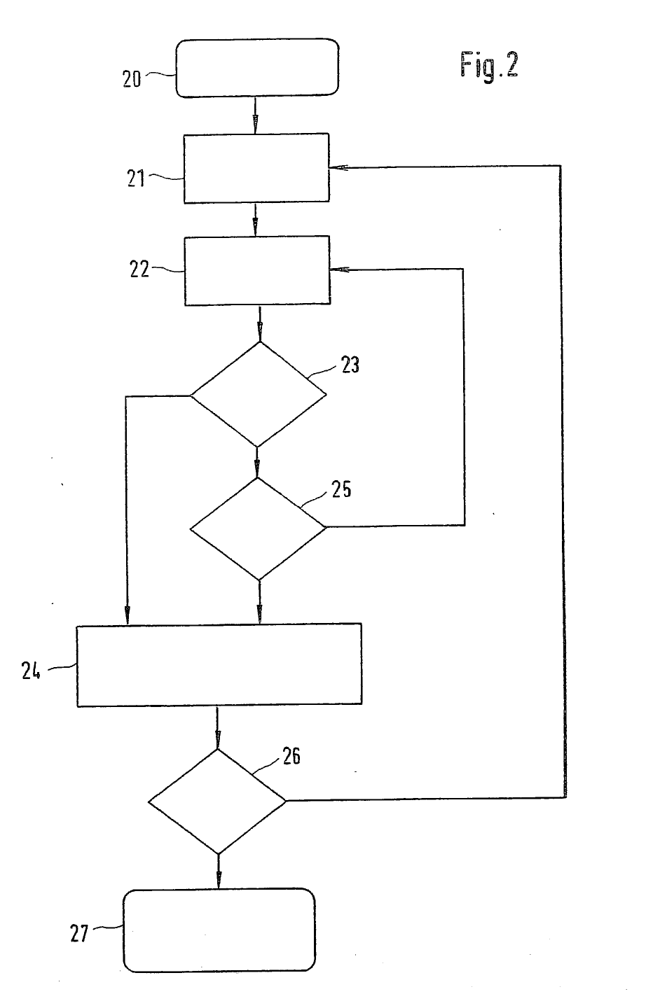

FIG. 2 shows a first method according to the present invention for controlling voice input/output unit 2. In an initializing step 20, the voice input and output in voice input/output unit 2 is activated by navigation device 1 by, for instance, transmitting the instruction to request a destination from a user. In a subsequent determination step 21, voice input/output unit 2 defines a question. For instance, if determination step 21 is reached the first time, a user is asked what type of destination is to be input, for example, an address, a hotel or tourist attraction. If determination step 21 is again reached in the further course, details of the destination to be input are requested, such as street name, house number, hotel type, type of tourist attraction. In a voice output step 22 following determination step 21, processing unit 11 outputs a first sequence of the question to be output via loudspeaker 10, for instance, the first word of the question. Further branching to a first test step 23 then takes place. In first test step 23, it is determined whether microphone 9 has detected a word spoken by a user of voice input/output unit 2. If this is the case, further branching to a voice input step 24 occurs. In a preferred embodiment, first test step 23 only to voice input step 24, if a predefined word such as “stop” spoken by the user is detected. In voice input step 24, words subsequently spoken by the user are detected and evaluated by processing unit 11. If it is determined in first test step 23 that microphone 9 has not detected any spoken word or any predetermined spoken word of a user, branching to a second test step 25 occurs. In second test step 25, it is determined whether the question defined in determination step 21 has already been output in its entirety. If this is the case, further branching to voice input step 24 also occurs. If this is not the case, branching back to voice output step 22 takes place and the next sequence of the question, for instance, the second word of the question, is output. Voice input step 24, which is not further depicted in FIG. 2, is ended, for example, when microphone 9 does not detect any additional spoken words or letters. Further branching to a third test step 26 then takes place. In third test step 26 it is ascertained whether the destination has already been unambiguously determined. If this is the case, further branching to an end step 27 is implemented, in which the voice input and output are concluded. The detected destination is forwarded to navigation device 1 and used for a route search. If it is determined in third test step 26 that the destination has not yet been unambiguously determined, branching back to determination step 21 occurs, and a new question is output to the user requesting further details of the destination. In a preferred embodiment, it is first asked whether the sequence that was input in voice input step 24 has been input correctly. Furthermore, it is also possible to consider the first word detected prior to the first test step as the first word of the voice input in voice input step 24.

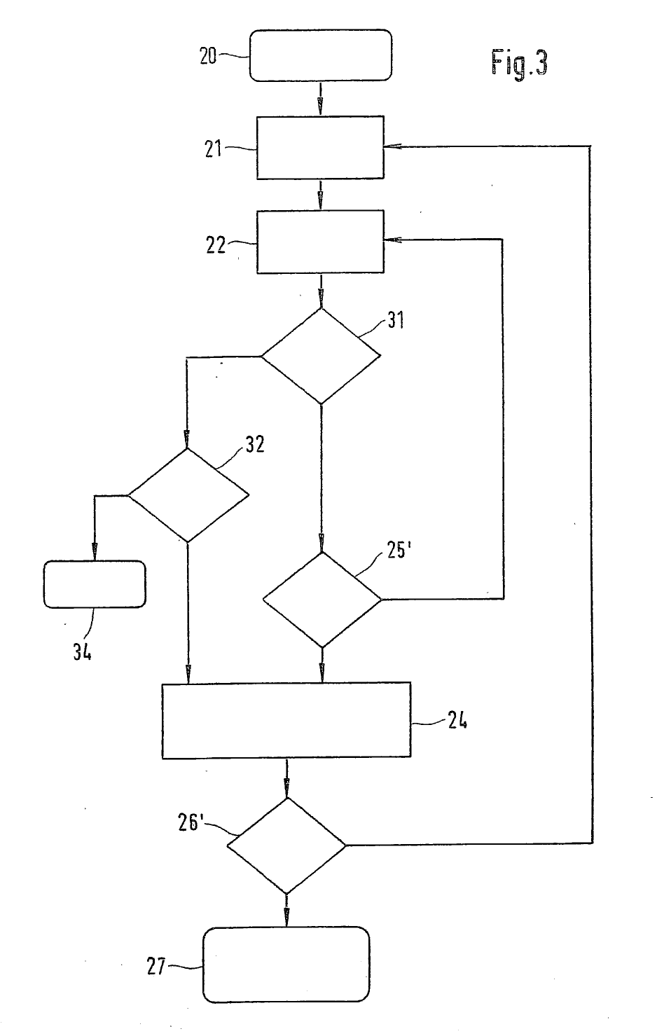

FIG. 3 shows a further embodiment of the control of a voice input/output unit 2 according to the present invention. The method commences with an initializing step 20, followed by determination step 21 and a voice output step 22, which correspond to steps of the same name elucidated with the aid of FIG. 2. In the method according to FIG. 3, voice output step 22 is followed by a first test step 31, in which it is examined whether a pushbutton 8 of input unit 7 has been pressed since last reaching first test step 31, or in first reaching first test step 31 since initializing step 20. If it is detected in first test step 31 that a pushbutton has been pressed, branching occurs to a second test step 32, in which it is determined in a first embodiment whether push button 8 has been pressed twice. If this is the case, further branching to an end step 34 is implemented, in which the voice input and output are concluded. A destination is then input via pushbuttons 8 arranged on input unit 7. If it is detected in test step 32 that the push button has not been pressed twice, branching to voice input step 24 occurs, which corresponds to voice input step 24 according to FIG. 2. If a push button 8 has been pressed longer than a predetermined period of time, for instance, longer than two seconds, in a further embodiment, second test step 32 branches to end step 34. If it is detected in first test step 31 that no push button has been pressed, branching to third test step 25′ occurs, which in its contents corresponds to second test step 25 according to FIG. 2. A fourth test step 26′ corresponding to third test step 26 according to FIG. 2 follows voice input step 24. End step 27 also corresponds to end step 27 according to FIG. 2.

What is claimed is:

1. A method for controlling a voice input and output, in which a voice output is activated, wherein the voice output is interrupted by a user input, and the voice input is activated by the user input.

2. The method as recited in claim 1,
wherein a microphone is activated during the voice output, and the voice output is interrupted when a spoken word is detected.

3. The method as recited in claim 2,
wherein the voice output is interrupted only if a predefinable word is detected.

4. The method as recited in one of the preceding claims, wherein the voice output is interrupted by pressing a push button.

5. The method as recited in one of the preceding claims, wherein the voice input and output are deactivated by pressing a push button.

6. The method as recited in claim 5,
wherein the voice input and output are only deactivated if a push button is pressed twice and/or when the time the pushbutton is pressed exceeds a predefined period of time.

7. The method as recited in one of the preceding claims, wherein the voice output is activated anew after the voice input has been completed.

8. The method as recited in one of the preceding claims, wherein the voice output outputs a prompt for a voice input.

9. The method as recited in one of the preceding claims, wherein a signal detected by the microphone and a signal output via loudspeaker are forwarded to a filter unit, and the signal detected by the microphone is filtered.

10. A device for implementing the method as recited in one of the preceding claims, preferably for inputting a destination into a navigation device in a motor vehicle.
